(19) United States
(12) Patent Application Publication
(10) Pub. No.: US 2020/0216570 A1
(43) Pub. Date: Jul. 9, 2020

(54) METHOD AND APPARATUS FOR CONCENTRATING CRYSTALLINE NANOCELLULOSE

(71) Applicant: Precision Biomass Dehydration Corporation, Wisconsin Rapids, WI (US)

(72) Inventors: John F. Bergin, Wisconsin Rapids, WI (US); Bernard Lager, III, Wisconsin Rapids, WI (US)

(73) Assignee: Precision Biomass Dehydration Corporation, Wisconsin Rapids, WI (US)

(21) Appl. No.: 16/053,973

(22) Filed: Aug. 3, 2018

Related U.S. Application Data
(60) Provisional application No. 62/541,468, filed on Aug. 4, 2017.

(51) Int. Cl. C08B 15/02

(52) U.S. Cl. CPC C08B 15/02

(57) ABSTRACT

The claimed invention is directed to continuous process for dehydrating nanocellulose using a combination of evaporative cooling and sublimation cooling. The continuous process begins with a slurry of nanocellulose material and operates to dehydrate the material without causing agglomeration or loss of structure. Such dehydrated nanocellulose material is very useful when incorporated into structural materials.

### FIELD OF THE INVENTION

The present invention relates to nanocellulose material, especially nanocellulose material of plant origin. More specifically, the claimed invention relates to a scalable, continuous process for dehydrating crystalline nanocellulose.

### BACKGROUND OF THE INVENTION

Cellulose nanomaterials have demonstrated potential applications in a wide array of industrial sectors, including electronics, construction, packaging, food, energy, health care, automotive, and defense. Cellulose nanomaterials are projected to be less expensive than many other nanomaterials and, among other characteristics, tout an impressive strength-to-weight ratio. Furthermore, cellulose nanomaterials have proven to have major environmental benefits because they are recyclable, biodegradable, and produced from renewable resources. Additionally, cellulose nanomaterials have manufacturer-friendly attributes such as low thermal expansion, low density and abrasiveness, high specific stiffness and strength.

The commercialization of cellulose nanomaterials in the United States has the potential to create hundreds of thousands of direct and indirect jobs and, in particular, would strongly benefit rural America. In addition, the United States possesses the resources and the infrastructure to support a large cellulose nanomaterials industry.

Cellulose nanomaterials are nanoscale materials isolated from trees, other plants, and algae or generated by bacteria and tunicates. Different raw material sources, as well as different production methods, will lead to cellulose nanomaterials with differing morphology and properties, such as length, aspect ratio, branching, and crystallinity. With respect to commercialization, two major categories of cellulose nanomaterials have received the greatest interest: cellulose nanocrystals (CNCs) and cellulose nanofibrils (CNFs). Cellulose nanocrystals and cellulose nanofibrils are obtained from wood pulp or other cellulose sources by two contrasting methods. For example, cellulose nanocrystals are produced by acid hydrolysis of wood fiber or other cellulosic materials. The process produces rod-like nanoscale materials that are 3-20 nm wide and 50-500 nm in length. Alternatively, cellulose nanofibrils are produced using mechanical processes with or without chemical (e.g., 2,2,6,6-tetramethylpiperidine-1-oxyl, or TEMPO) and biological (e.g., enzyme) treatments to produce fibril-like nanoscale materials. CNFs are 4-50 nanometers wide, longer than 500 nanometers in length, and can be single strands or branched. The range of cellulose nanomaterial morphologies and properties supports a variety of potential applications across multiple industries.

Cellulose nanomaterials could lead to many novel applications and products. All forms of cellulose nanomaterials are lightweight, strong, and stiff. CNCs possess photonic and piezoelectric properties, while CNFs can provide very stable hydrogels and aerogels. In addition, cellulose nanomaterials have low materials cost potential compared to other competing materials and, in their unmodified state, have shown few environmental, health, and safety concerns. Currently, cellulose nanomaterials have demonstrated great potential for use in many areas, including aerogels, oil drilling additives, paints, coatings, adhesives, cement, food additives, solar, lightweight packaging materials, paper, health care products, tissue scaffolding, lightweight vehicle armor, space technology, and automotive parts. Hence, cellulose nanomaterials have the potential to positively impact numerous industries.

An important attribute of cellulose nanomaterials is that they are derived from renewable and broadly available resources (i.e., plant, animal, bacterial, and algal biomass). They are biodegradable and bring recyclability to products that contain them. For example, CNC and CNF could be coupled with polylactic acid (PLA) to provide a fully biologically sourced and biodegradable fiber-reinforced composite, and incorporation of biodegradable cellulose nanomaterials allows for the production of recyclable electronics. Hence, cellulose nanomaterials may reduce environmental impacts by enabling post-consumer disposability and recyclability of many products. Cellulose nanomaterials sequester carbon and can be a substitute for fossil fuel derived products in various applications. Therefore, the potential environmental benefits of producing and using cellulose nanomaterials are substantial.

Market opportunities are also substantial. For example, in the electronics industry, there is a potential for cellulose nanomaterial-enabled composites and materials to be used as substrates in flexible electronics, in housings, and even in some electronic components. This market opportunity is enhanced by the ability of cellulose nanomaterials to enable a more sustainable and environmentally friendly disposal of used or obsolete products, either through recycling or improved biodegradability.

Additional market opportunities exist for cellulose nanomaterials to serve as composite or polymer reinforcements. In this market, the cellulose nanomaterials provide a range of possible value-adding characteristics, including improved strength, lightweighting, shape memory, and water absorbency. Cellulose nanomaterials can substitute for petroleum-based additives and thus increase the sustainability of composite materials. Cellulose nanomaterials also can improve the biodegradability of the material. Cellulose nanomaterials have the potential to enable the development of new composite materials with new value-added properties.

Unfortunately, efforts to commercialize cellulose nanomaterials have been moving slowly. Commercialization is inhibited by the lack of processing and production methods and know-how for ensuring uniform, reliable, and cost-effective production of cellulose nanomaterials. This is both a scale-up and a process control issue. Commercialization of cellulose nanomaterials into large volume markets will require increases in production capacity to ensure supply and lower costs. This level of production capacity has not been demonstrated, nor is largescale process equipment available. There is also a need for better process control capability to ensure quality, including nanoscale measurement and manipulation capabilities. Nanocellulose generation today whether via mechanical or chemical means results in a low solids dispersion of the nanocellulose material as low as 1-3% solids in a dominantly aqueous medium.

One of the most significant technical challenges identified is the dewatering of cellulose nanomaterials into a dry and usable form for incorporation into other materials. Specifically, prior methods for dehydration fail to preserve the structure and function of cellulose nanomaterials. Numerous drying methods have been including lyophilization, drying by extraction from the supercritical state and spray drying. Unfortunately, the lack of an effective, uniform, scalable, continuous drying process has inhibited the commercialization of cellulose nanomaterials. Cellulose nanomaterials in low-concentration aqueous suspensions raise resource and transportation costs, which make them significantly less viable commercially.

### SUMMARY OF THE INVENTION

The claimed invention provides a uniform, scalable process for dehydrating cellulose nanomaterials. The claimed invention also provides for an energy efficient and cost effective dehydrating process. The claimed invention further provides for a process for increasing the solid content of a nanocellulose slurry from approximately 10% to approximately 99% or to any intermediate percentage, while preserving the structure and function of the nanocellulose.

### BRIEF DESCRIPTION OF THE DRAWINGS

FIG. 1 is a side elevational view of the discharge end of an exemplary dryer.

FIG. 2 is a top and side perspective view of the removal knife of an exemplary dryer.

FIG. 3 is a top and side perspective view of an exemplary dryer with multiple zones.

FIG. 4 is a top and side perspective view of another example of an exemplary dryer.

FIG. 5 is a top and side elevational view of an exemplary dryer.

FIG. 6 shows the rheology results for the control sample of nanocellolose.

FIG. 7 shows the rheology results for a sample of nanocellulose that was dehydrated to 45.2% nanocellulose by weight.

FIG. 8 shows the rheology results for a sample of nanocellulose that was dehydrated to 37.7% nanocellulose by weight.

FIG. 9 shows a micrograph from an electron scanning microscope showing nanocellulose showing the control sample of nanocellulose at 1.00 um magnification.

FIG. 10 shows a micrograph from an electron scanning microscope showing nanocellulose showing an example of agglomeration in the control sample at 1.00 um magnification.

FIG. 11 shows a micrograph from an electron scanning microscope showing nanocellulose at 500 nm magnification that was diluted from a 95.7 percent dehydrated sample.

### DETAILED DESCRIPTION OF THE INVENTION

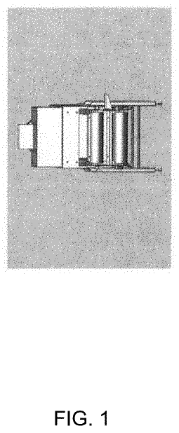

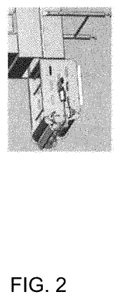

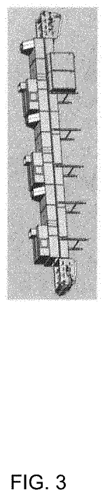

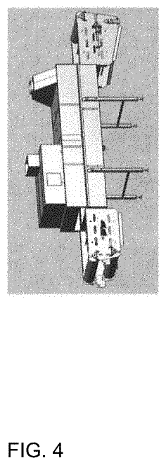

Now referring to the drawings in detail, wherein like reference numerals refer to like elements throughout, FIG. 1 shows a conveyor type heater with several elements including, but not limited to, rollers, a belt and a hood (not shown). The conveyor-type heater is generally structured around a conveyor table which provides for continuous or indexed operation of the conveyor belt. (not shown) Conveyor components, including drive controls are controlled by a Programmable Logic Controller (PLC) that is operable to index or to drive the belt continuously.

The moving belt (not shown) comprises a synthetic material such as nylon, ceramic coated stainless steel or Teflon coated fiberglass. In a preferred embodiment, the belt will facilitate the holding of the slurry material in place and will also aid in the removal of the dehydrated material at the dryer exit. The belt will run at speeds between at least 0.1 to 10 feet per minute. Of course, the belt may run either faster or slower with the same results depending on the other machine conditions such as the length of the drying areas, the belt temperature, air temperature and air volume.

Slurry material can be applied to the belt via spray application. A typical spray application would begin with slurry of processed crystalline nanocellulose material that is in the range of approximately 1-10% solids. The slurry material is tested prior to application using a moisture analyzer and regulated to achieve a uniform consistency. The slurry material is applied to the belt at a thickness between 0.001 inches and 0.080 inches thick. Typically, in a spray application, the slurry material could be applied to the belt at a rate of between 100 and 500 grams/minute/foot of belt, the application rate depending on the speed of the belt and the desired level of dehydration. The slurry material is spray applied via a dynamic nozzle with a fanning port of between 0.020 inches to 0.060 inches at between 40 psi and 100 psi.

Slurry material may also be calendared onto the belt using, for example, a stationary roller. The application height of the slurry material can be varied at least between 0.037 inches and 0.066 inches, and potentially between 0.001 inches and 0.100 inches, depending on the level of dehydration desired as well as other conditions of dehydration.

Once the slurry material is sprayed or calendared onto the belt, the belt advances the material through a temperature-controlled area or preferably through a plurality of temperature controlled areas. In one embodiment, the slurry material is conveyed through two or more temperature and pressure controlled areas. In a preferred embodiment, the heater is comprised of three temperature and pressure controlled areas. Each temperature controlled area is comprised of a temperature controlled plate situated under the belt operable to heat or cool the belt. The heating function of the temperature controlled plate is generally electric, but other means of heating could also be used. Temperature controlled plate is operable to increase the temperature of the material between approximately 10 degrees F. and 320 degrees F. as might be required. Temperature controlled plate may be cooled via circulating refrigerated fluid, but other cooling means are also possible. Cooling means should be operable to cool the material between approximately 1 degree F. and 180 degrees F. over the length of the cooling plate, depending on the particular material specification. The dryer may employ a single temperature controlled plate which would create a single heating and cooling cycle or a plurality of temperature controlled plates such that multiple cycles are possible. Multiple cycles of heating and cooling may be induced by conveying the material over several sets of temperature controlled plates to dehydrate the material to a selected level. In one exemplary dehydration machine, each temperature controlled area is approximately eight (8) feet long and there are a total of three (3) temperature-controlled areas. Belt temperatures are carefully monitored using an infrared sensor, although other types of sensors could be used to monitor the temperature of the belt.

The ambient temperature of the air supply plenum is also controlled. In one example, the air supply to the first heating zone is set to 300 degrees F. while the air supply to the second and third heating zones is set to 500 degrees F., although other temperature values could also be used. An exhaust fan, or more preferably, an exhaust fan per heating zone, removes the heated air, now containing water from the drying materials. While air temperature is an important measurement, air volume is as well. In the relatively small plenums over each of the heating zones, air volumes were in the 500 cubic feet/minute range. Air temperature is measured using a resistance temperature detector, although other types of air temperature measuring devices are certainly possible. Upon completing the drying section, material will be removed from the belt using a scraping knife comprising ultra-high molecular weight material applied to a roller of radius sufficient (between 2 and 12 inches) to facilitate discharge of the material into a collection bin.

In one experiment, three tests were run with 500 gram samples. Material was applied to the belt with no pan heat. Conveyor speed was set to approximate an 8 minute conveyor transit time. With no pan heat and an approximately 8 minute retention time, little water loss was observed. Pan heat and retention time were increased until the resulting product was approximately 50% solids. After identifying these initial parameters, three additional tests were performed, again using 500 g sample sizes. The only variable altered in tests 4-6 was the application height of the nanocellulose slurry.

| | Original | Transit | Application | | |
|---|---|---|---|---|---|
| | Percent | Time | Height | Percent | |
| Test | Solids | (minutes) | (mil) | Solids | Appearance |
| 4 | 10.8% | 7.8 | 66 | 10.8% | Gel - like |
| | | | | | petroleum jelly |
| 5 | 10.8% | 7.8 | 52 | 33.7% | Tacky - sticky |
| | | | | | gel |
| 6 | 10.8% | 7.8 | 371 | 95.0% | Dry, crystalline |
| | | | | | flakes |

Testing of each sample, including the base material, were undertaken using Dynamic Light Scattering. Dynamic Light Scattering (DLS, also known as Photon Correlation Spectroscopy or Quasi-Elastic Light Scattering) allows particle sizing down to 1 nm diameter. Tests using Dynamic Light Scattering were obtained by making 3% suspensions with the dehydrated slurry material provided using glass beads in the vial to help with mixing/dispersion. All suspensions looked clear with some Rayleigh scattering except test 6 from 95% solids which was obviously hazy and had some particles that could be seen with the naked eye. These samples were diluted further to 0.1 wt % nanocellulose for Dynamic Light Scattering (DLS) testing. Data was collected for each sample as five sequential two-minute sampling times. Test 6 was also tested after being centrifuged. The samples were all run detecting scatter at 90 degrees to the laser beam. The starting material and Test 6 were also run with forward scattering. Initial light scattering results indicate a rehydrated particle size very close to original particle size, indicating that the nanocellulose retained its structure and function through the dehydration process. Further experiment revealed results consistent with the initial results. The ensuing results demonstrate the viability of a continuous, controlled dehydration process.

### Trial 1

Exemplary trials included the following examples. Trial 1 was conducted under the following conditions:

| | Zone 1 | Zone 2 | Zone 3 |
|---|---|---|---|
| Air Heat Temp (F./Hz) | 300/20 Hz | 500/20 Hz | 500/20 Hz |
| Air Heater Temperature | 288 | 477 | 336 |
| Pan 1 Temperature | 150 | 150 | 150 |
| Pan 2 Temperature | 150 | 150 | 150 |
| Product Temperature | 129 | 134 | 126 |
| Air Temperature | 146 | 144 | 137 |

It must be noted that the heaters themselves may not reach the designated setpoints due to environmental variables such as the starting material temperature, temperature of the incoming air, fluctuations in the amount of incoming air, the temperature of the machine and the amount of material on the machine. Trial 1 employed a drying time of 27 minutes. Material calendar height was set to 0.038 inches. Exhaust was set at 48% (explain) that is, 1400 cubic feet/minute supply and 1485 cubic feet/minute exhaust. The concentrated material produced by the dehydration process was approximately 37% solids, nearly identical to other results under similar control conditions.

### Trial 2

Trial 2 used settings identical to those employed in Trial 1, except for the material height and retention time. For Trial 2, a material height of 0.040 inches and a retention time of 34 minutes were used. The increased retention time resulted in a more concentrated result that was approximately 95% solids. Again, similar testing conditions resulted in very similar dehydration effects demonstrating the repeatability of this method.

### Trial 3

Trial 3 was conducted under the following conditions:

| | Zone 1 | Zone 2 | Zone 3 |
|---|---|---|---|
| Air Heat Temp (F./Hz) | 125/20 Hz | 125/20 Hz | 125/20 Hz |
| Air Heater Temperature | ? | ? | ? |
| Pan 1 Temperature | 100 | 100 | 100 |
| Pan 2 Temperature | 100 | 100 | 100 |
| Product Temperature | 92 | 83 | 94 |
| Air Temperature | 86 | 74 | 82 |

Trial 3 used a retention time of 80 minutes, but significantly lower temperatures than those used in Trial 1 and Trial 2. Material was conveyed onto the conveyor belt at approximately 0.038 inches. The significantly longer retention time resulted in a material that was approximately 99% solids. Again, repeated tests yielded similar results.

### Trial 4

Trial 4 was conducted using very high heat relative to the above references trials shown below:

| | Zone 1 | Zone 2 | Zone 3 |
|---|---|---|---|
| Air Heat Temp (F./Hz) | 990/5 Hz | 990/5 Hz | 990/5 Hz |
| Air Heater Temperature | ? | ? | ? |
| Pan 1 Temperature | 420 | 420 | 420 |
| Pan 2 Temperature | 420 | 420 | 420 |
| Product Temperature | 198 | 301 | 253 |
| Air Temperature | 137 | 290 | 253 |

Material application height was set to 0.050 inches. Retention time was set to sixty (60) minutes. The resulting material was approximately 99% solids, but was visibly damaged.

### Trial 5

Trial 5 was designed to target and end product that was approximately 45%-50% solids material. With that in mind, applicant set the following parameters:

| | Zone 1 | Zone 2 | Zone 3 |
|---|---|---|---|
| Air Heat Temp (F./Hz) | 300/20 hz | 500/20 Hz | 500/20 Hz |
| Air Heater Temperature | 288 | 477 | 336 |
| Pan 1 Temperature | 150 | 150 | 150 |
| Pan 2 Temperature | 150 | 150 | 150 |
| Product Temperature | 125 | 132 | 124 |
| Air Temperature | 144 | 143 | 134 |

The material application height was set to 0.050 inches and retention time was set to forty (40) minutes. The resulting material was approximately 45.2 solids by weight.

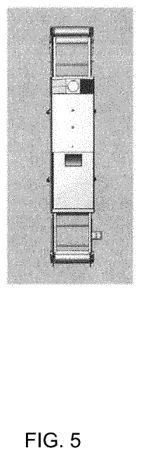

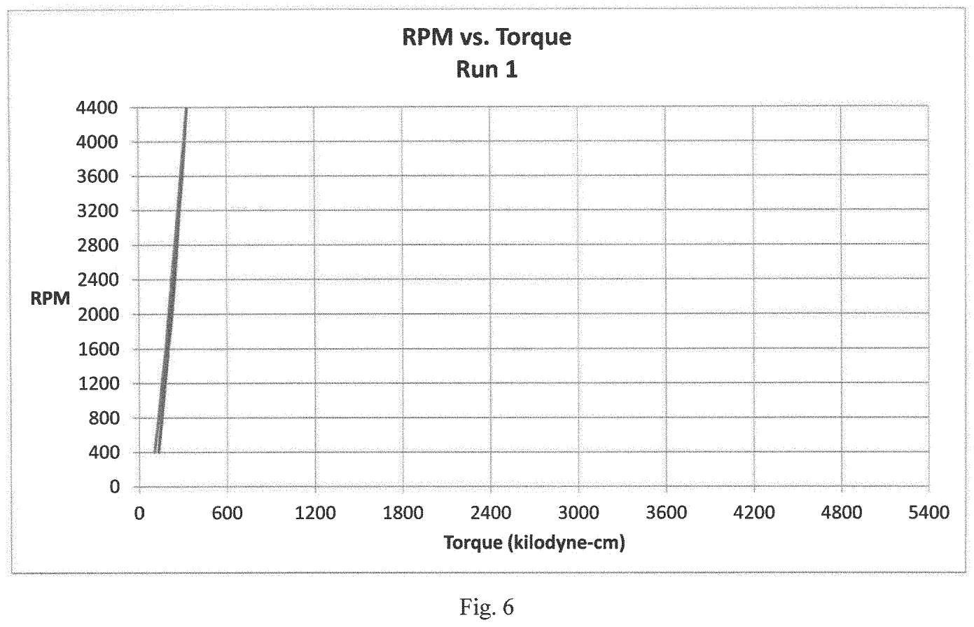

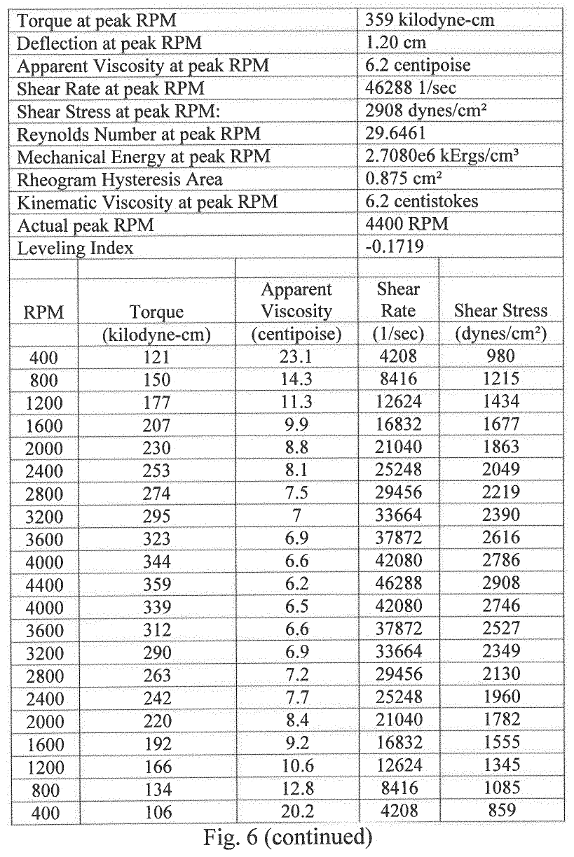

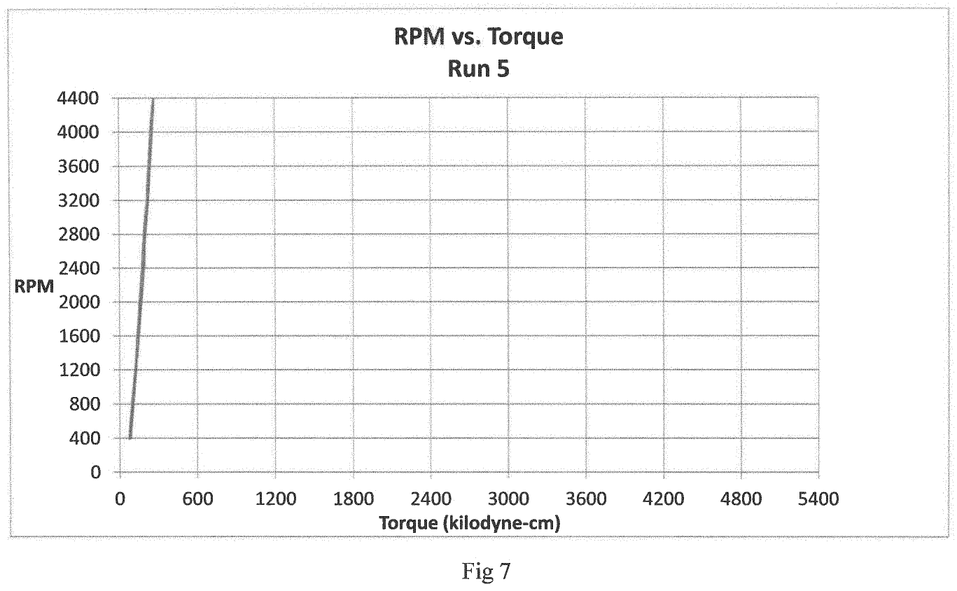

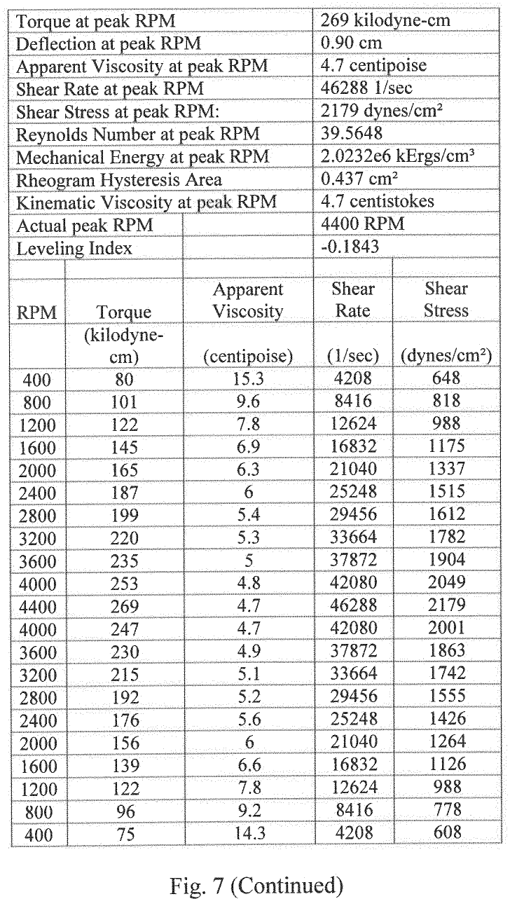

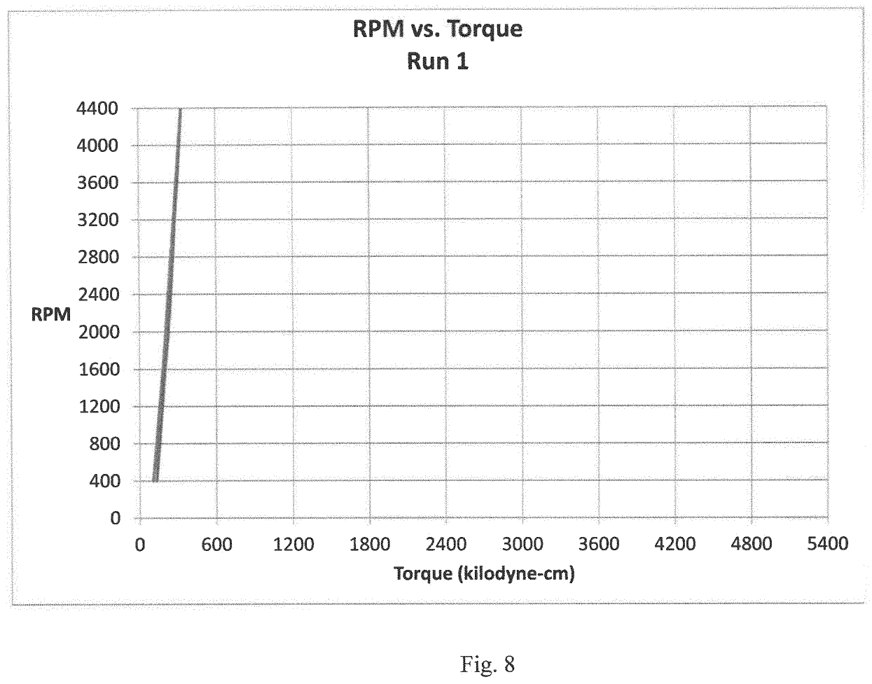

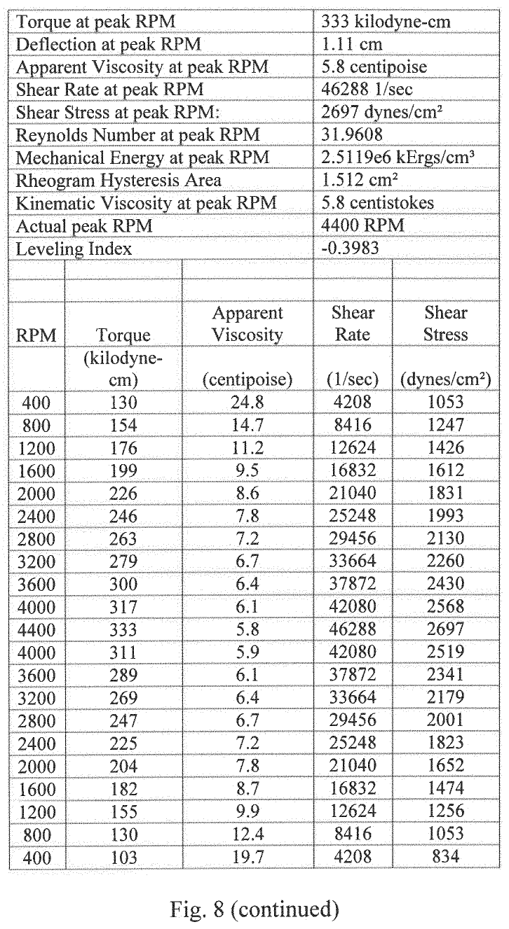

Testing of each sample, including the base material was again undertaken using Dynamic Light Scattering. As before, tests using Dynamic Light Scattering were obtained by making 3% suspensions with the dehydrated material produced in the above-referenced trials. All suspensions were clear in appearance with some Rayleigh scattering except test 6 from 95% solids which was visibly hazy and had some particles that could be seen with the naked eye. These samples were diluted further to 0.1 wt % nanocellulose for Dynamic Light Scattering (DLS). As before, testing via Dynamic Light Scattering reveals a particle size that is very similar to the starting material. That said, Dynamic Light Scattering may not sufficiently sensitive in detecting the required particle size to provide conclusive results. Rheology testing was also performed in an effort to measure the differences between the dehydrated nanocellulose materials and the starting material. Rheology test results of the original nanocellulose, 45.2% dehydrated nanocellulose and the 37.7% dehydrated nanocellulose are shown in FIGS. 5-7 for comparison. Specifically, the material from each of the above-referenced tests was rediluted to match the solids content of the starting material, that is, 10.7% solids.

| | Heater Settings | | | | | | |
|---|---|---|---|---|---|---|---|
| | Standard | Standard | Low Temp | High Temp | Standard | Original CNC | |
| | Moisture (pre dilution) | | | | | | |
| | 37.70% | 95.80% | 95.10% | 99.20% | 45.20% | 10.70% | |
| Sample | 1 | 2 | 3 | 4 | 5 | 6 | Units |
| Torque at peak RPM | 333 | 457 | 436 | 532 | 269 | 359 | Kilo- |
| | | | | | | | dyne-cm |
| Deflection at | 1.11 | 1.52 | 1.45 | 1.77 | 0.9 | 1.2 | cm |
| peak RPM | | | | | | | |
| Apparent Viscosity at | 5.8 | 7.9 | 7.6 | 9.2 | 4.7 | 6.2 | centi- |
| | | | | | | | poise |
| Shear Rate at | 46288 | 46288 | 46288 | 46288 | 46288 | 46288 | 1/sec |
| peak RPM | | | | | | | |
| Shear Stress at peak | 2697 | 3702 | 3532 | 4309 | 2179 | 2908 | dynes/cm² |
| Reynolds Number | 31.9608 | 23.2887 | 24.4104 | 20.0055 | 39.5648 | 29.6461 | |
| at peak | | | | | | | |
| Mechanical Energy at | 2511900 | 3447200 | 3288800 | 4012900 | 2023200 | 2708000 | kErgs/cm³ |
| Rheogram Hysteresis | 1.512 | 3.521 | 3.498 | 8.904 | 0.437 | 0.875 | cm² |
| Area | | | | | | | |
| Kinematic Viscosity at | 5.8 | 7.9 | 7.6 | 9.2 | 4.7 | 6.2 | centi- |
| | | | | | | | stokes |
| Actual peak RPM | 4400 | 4400 | 4400 | 4400 | 4400 | 4400 | RPM |
| Leveling Index | −0.3983 | −1.1567 | −1.0953 | −4.3684 | −0.1843 | −0.1719 | |
| Average of Bold | 93% | 74% | 79% | 54% | 74% | 100% | |

The table allows a comparison between each sample material to the starting material. An average of the differences in the rheology results was used to approximate a score that represents the difference between each sample and the starting material. Sample 1 is essentially unchanged from the starting material. Samples 2 and 3 are very similar to the starting material. Sample 3—the low temperature sample—is slightly closer to the starting material. Sample 4—the high temperature sample—is clearly deficient. Sample 5 varies just as much as Samples 2 and 3. However, it varies in the opposite direction—which would seem to indicate less agglomeration of the nanocellulose.

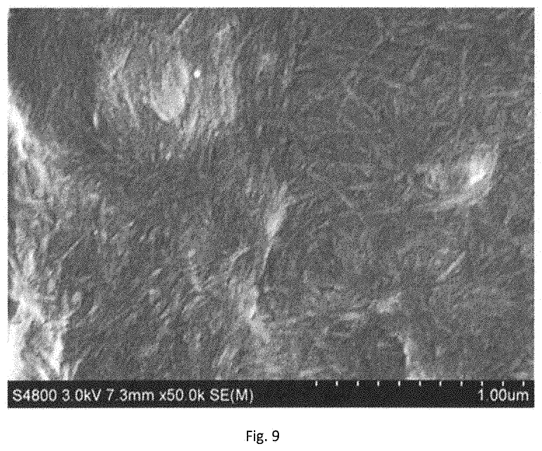

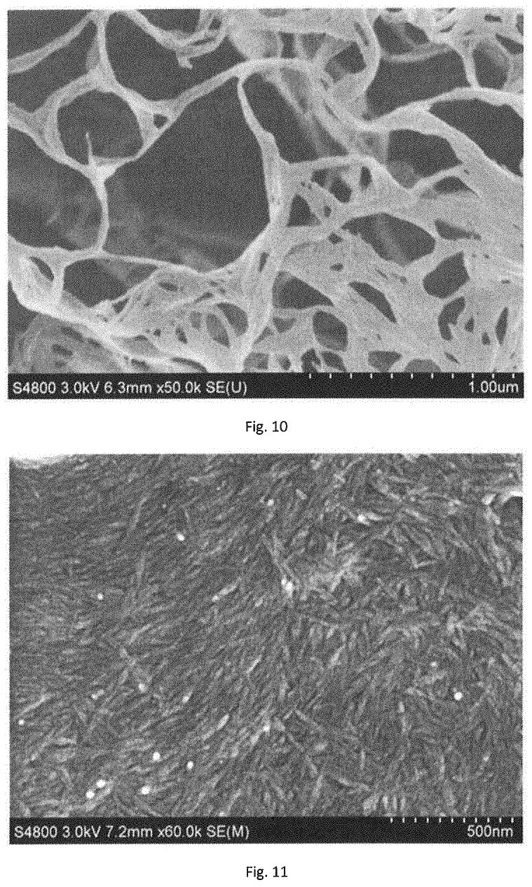

Further testing of samples was undertaken using electron scanning microscopy to confirm the structure of the nanocellulose material was not damaged by the dehydration process. FIG. 9 shows a sample of the starting nanocellulose material examined using electron scanning microscopy. Notably, even the starting material shows agglomeration such as that shown in FIG. 10, which can itself lead to some irregularities in results and may explain some of the variation in other test results. Dehydrated materials in Sample 3 as shown in FIG. 11 show a very similar, if not identical structure to the starting nanocellulose material in FIG. 9. This consistency in results leads to the strong conclusion that the nanocellulose material has been dehydrated in such a way that it can be successfully reconstituted and used with no loss of properties from its original state.

As will occur to those skilled in the art, depending upon the specific solid content and machine setup, there are a number of permutations of the above-discussed examples that would result in the same or similar levels of dehydration. For example, the slurry material could be applied at a thickness of between 0.001 and 0.080 inches thick with any number of different types and widths of spray nozzles. Additionally, it may be advantageous to run certain zones at higher or lower temperatures or pressures. For example it is envisioned that heating stages could heat the material to more than 250 degrees F. and cooling stages could cool the material even lower than 19 degrees F. as may be required. It is further envisioned that it may be more efficient to effect greater changes in the temperature of the product. Further advantages may result in the use of more or fewer heating and cooling zones and smaller temperature differentials between the heating and cooling zones. For example, throughput speeds may be improved by employing more temperature controlled zones. Additionally, heating and cooling zones need not be of the same or even similar length as depicted in the drawings.

A continuous process for dehydrating crystalline nanocellulose without degrading the quality or properties of the nanocellulose has been described herein. The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method for continuously dehydrating nanocellulose without creating agglomeration or loss of structure comprising the steps of:
depositing nanocellulose slurry material onto a continuous belt in a continuous process;
providing a temperature and pressure controlled area through which the belt is operable to move the nanocellulose slurry material;
advancing the slurry material deposited on the belt through the at least one temperature and pressure controlled area at a temperature and pressure and with a speed of advance sufficient to dehydrate the nanocellulose without causing agglomeration or loss of structure.
